(19) United States
(12) Patent Application Publication
(10) Pub. No.: US 2003/0089403 A1
(43) Pub. Date: May 15, 2003

(54) Swing-out backflow preventer

(76) Inventors: Patrick Wilson Duncan, Monroe, NC (US); John Frederick Higdon, Matthews, NC (US)

Correspondence Address: Adams, Schwartz & Evans, P.A., 2180 Two First Union Center, Charlotte, NC, 28282, US

(21) Appl. No.: 10/055,453

(22) Filed: Nov. 12, 2001

(51) Int. Cl. F16K 15/06

(52) U.S. Cl. 137/512

(57) ABSTRACT

A backflow prevention apparatus has a valve body with a longitudinal axis that defines a flow path therethrough, and two end segments located at opposite ends of the valve body. Two check valve assemblies reside in series within the valve body. The valve body and end segments are connected to a pivot member that carries the valve body and allows it to swing in and out of axial alignment with the end segments. The check valve assemblies can be accessed and removed from the valve body when the valve body is pivotally moved out of axial alignment with the end segments.

### TECHNICAL FIELD AND BACKGROUND OF THE INVENTION

This invention relates to a type of backflow prevention apparatus utilizing a check valve. Check valves are well known and are widely used to prevent the backflow of fluids carrying undesirable contaminants into a fluid supply. These valves have evolved to become highly specialized in their function and operation. Check valves are similar in that they all contain spring-loaded members that are biased towards the valve-closed position until fluid pressure acting on the checking members forces the valves open. Typically, a backflow prevention apparatus utilizes two check valves in a serial combination for preventing the backflow of a fluid. In a conventional design, the checking member is a poppet-type check in which the movement of the checking member is linear and remains in the fluid path. The energy required to open these check valves is provided by the fluid and is created at the source by, for example, a pump.

Such backflow preventers are commonly used today to prevent the contamination of public potable water supplies. Prior to 1974, most public piping systems in the United States were open systems. That is, the system allowed fluid to flow to and from the source in either direction. As the national population increased, instances of drinking water contamination became more frequent. In response, the United States government enacted legislation requiring the use of backflow preventers on most public potable water piping systems to stop contamination due to back-siphonage or backflow. As a result, most fluid piping systems were converted to closed systems allowing fluid to flow in one direction only.

Backflow preventers are required to meet standards set by government regulations. These regulations set minimum opening pressures for check valves, maximum rated pressures that the valve body must withstand, required flow rates at a given pressure loss, and material specifications. Furthermore, regulations governing backflow preventers require that a check valve and its associated parts must be removable for routine inspection and for field service repair without having to remove the valve body from the fluid conduit system to which it is attached.

Current backflow preventers require that threaded caps or a series of bolts be removed to gain access to the checks. This results in a considerable expense of time and effort in performing the necessary inspections and maintenance on the backflow preventers. In addition, current producers of backflow preventers use cumbersome retaining clips or spacers to hold checks in place in the apparatus, which are often hard to install.

### SUMMARY OF THE INVENTION

Therefore, it is an object of the invention to provide an improved backflow prevention apparatus utilizing dual check valve assemblies that can be easily and readily removed for inspection and maintenance, with minimal tools, effort and training on the part of the user.

It is another object of the invention to provide a backflow prevention apparatus in which check valves contained within the apparatus can be easily and quickly serviced without removing the apparatus from a pipe line.

It is another object of the invention to provide a backflow prevention apparatus having a valve body that can swing out of axial alignment with two valve body end segments when a connecting rod is removed to allow access to dual check valve assemblies contained within the valve body, while the apparatus remains otherwise intact.

It is another object of the invention to provide a backflow prevention apparatus that does not require threaded caps or bolts to be removed in order to gain access to the check valves.

It is another object of the invention to provide a backflow prevention apparatus that does not require retaining clips or spacers to hold check valves in place within the apparatus.

It is another object of the invention to provide a backflow prevention apparatus that utilizes single piece check valve assemblies that can be positioned in the apparatus in one direction only.

It is another object of the invention to provide a backflow prevention apparatus that utilizes an alignment screw and aperture to ensure proper alignment and a tight seal between a valve body and valve body end segments.

It is another object of the invention to provide a backflow prevention apparatus having a pressure relief valve that includes a relief valve stem that allows fluid to flow through the stem rather than around it.

These and other objects of the present invention are achieved in the preferred embodiments disclosed below by providing a swing-out backflow preventer comprising a valve body with a longitudinal axis that defines a flow path therethrough, and two end segments located at opposite ends of the valve body. Two check valve assemblies reside in series within the valve body. The valve body and end segments are connected to a pivot member that carries the valve body and allows it to swing in and out of axial alignment with the end segments. The check valve assemblies can be accessed and removed from the valve body when the valve body is pivotally moved out of axial alignment with the end segments.

According to one preferred embodiment of the invention, the valve body is carried by the pivot member for pivotal movement in clockwise and counterclockwise directions.

According to another preferred embodiment of the invention, the check valve assemblies are a single piece check valves.

According to yet another embodiment of the invention, the check valve assembly and the valve body are constructed such that the check valve assemblies can be positioned within the valve body in one direction only, thereby preventing backflow that would result from the check valve being installed in the wrong direction.

According to yet another embodiment of the invention, the pivot member comprises a rod connected to the valve body end segments and extending parallel to the longitudinal axis of the valve body.

According to yet another embodiment of the invention includes a relief valve connected to the valve body at a point between the two check valve assemblies. The pressure relief valve serves as a precautionary measure to prevent backflow in the event of a failure in the check valve assemblies. When the backflow pressure reaches a predetermined level and the second check valve assembly fails to close, the relief valve opens and the fluid is evacuated through a relief port.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a vertical, partial cross-sectional view of a swing-out double check valve backflow preventer of the present invention;

FIG. 2 is a perspective view of the backflow preventer of FIG. 1 in the valve-closed position;

FIG. 3 is a perspective view of the backflow preventer of FIG. 1 in a valve-open position, and the check valve assemblies contained within the valve body;

FIG. 4 is a perspective view of the backflow preventer of FIG. 1 in the valve-open position with the two check valve assemblies removed from the valve body;

FIG. 5 is a vertical, partial cross-sectional view of an embodiment of a double check valve backflow preventer of the present invention having a pressure relief valve;

FIG. 6 is a vertical, partial cross-sectional view of the backflow preventer of FIG. 5 showing the pressure relief valve in the closed position;

FIG. 7 is a perspective view of the backflow preventer of FIG. 5 in a valve-closed position;

FIG. 8 is a perspective view of the backflow preventer of FIG. 5 in a valve-open position and the two check valve assemblies contained within the valve body;

FIG. 9 is a perspective view of the backflow preventer of FIG. 5 in the valve-open position with the check valve assemblies removed from the valve body;

FIG. 10 is a perspective view of the check valve assemblies of the present invention;

FIG. 11 is a vertical, partial cross-sectional view of a valve body end segment and a portion of the valve body of the present invention showing the valve body to be in axial alignment with the end segment;

FIG. 12 is a vertical, cross-sectional view of the end segment and valve body portion of FIG. 11 showing the valve body out of axial alignment with the end segment;

FIG. 13A is an enlarged vertical cross-sectional view of an alignment screw and aperture as shown in FIG. 11;

FIG. 13B is a vertical cross-sectional view of the alignment screw in a position midway between the positions shown in FIGS. 11 and 12;

FIG. 13C is an enlarged vertical cross-sectional view of the alignment screw and aperture as shown in FIG. 12;

FIG. 14 is a perspective view of a plunger assembly of the present invention;

FIG. 15 is a front elevation of the plunger assembly shown in FIG. 14; and

FIG. 16 is a vertical, partial cross-sectional view of the plunger assembly shown in FIG. 15, rotated 90 degrees from the stem.

### DESCRIPTION OF THE PREFERRED EMBODIMENT AND BEST MODE

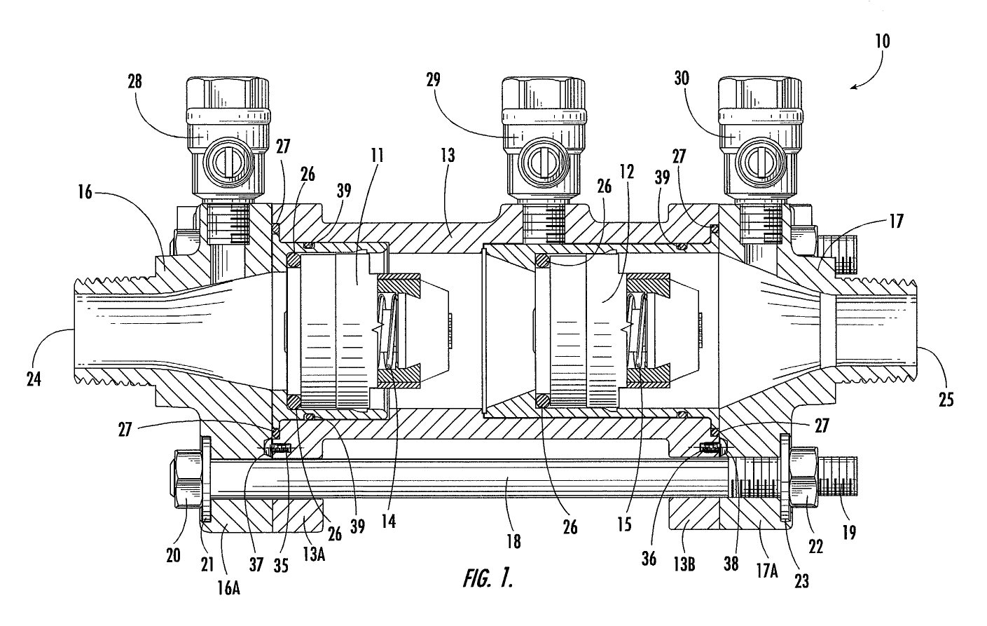

Referring now specifically to the drawings, a preferred embodiment of a backflow preventer according to the present invention is illustrated in FIGS. 1-4, and shown generally at reference numeral 10. In the embodiment shown therein, the backflow preventer 10 includes two check valve assemblies 11 and 12, sharing the same valve body 13. Serial combination of two check valves in a valve body to form a backflow preventer is well known in the art and thus will not be described in detail.

The check valve assemblies 11, 12 reside in series in the valve body 13. Springs 14, 15 bias check valve assemblies 11, 12, respectively, in a closed position. The check valve assemblies 11, 12 preferably have single piece check valves rather than multi-piece check valves that require field assembly. In addition, the check valve assemblies 11, 12 and the interior of the valve body 13 are configured such that the check valve assemblies 11, 12 can be inserted into the valve body 13 in one direction only, thus preventing backflow that would result from the check valve assemblies being inserted in the wrong direction. The valve body 13 is hollow and cylindrical, and preferably brass.

The backflow preventer 10 is connected to a pipe line by two valve body end segments 16 and 17. The valve body 13 is pivotally attached to the end segments 16, 17 by a pivot rod 18 that is connected to the exterior of the valve body 13 and runs parallel to the longitudinal axis of the valve body 13. The pivot rod 18 has screw threads 19 at respective ends. The pivot rod 18 extends through the first end segment 16 through a hole defined by a bushing 16A extending radially outwardly from an end segment 16, through bushings 13A and 13B extending radially outwardly from the valve body 13, and a bushing 17A extending radially outwardly from the other end segment 17. The pivot rod 18 is held in place at the first end segment 16 by a nut 20 and washer 21. The pivot rod 18 is likewise held in place at the second end segment 17 by a nut 22 and washer 23. The pivot rod 18 enables the valve body 13 to pivotally move in and out of axial alignment with the end segments 16, 17 along a single axis parallel to a longitudinal axis of the valve body 13.

The longitudinal axis of valve body 13 defines a flow path therethrough. Fluid enters the backflow preventer 10 through an inlet aperture 24 defined by the first end segment 16, and exerts pressure on the first check valve assembly 11. Under static conditions, the check valves within the check valve assemblies 11, 12 are biased closed by springs 14, 15, respectively. When the inlet pressure on the first check valve assembly 11 reaches a predetermined level, the first check valve assembly 11 opens, allowing fluid to flow therethrough to the second check valve assembly 12, which likewise opens when the pressure against it reaches the predetermined level. After passing through the second check valve assembly 12, the flow stream exits the backflow preventer 10 downstream through an outlet aperture 25 defined by a valve body end segment 17. In the event of a backpressure situation (i.e., the inlet pressure falls within a predetermined value of the outlet pressure), both check valve assemblies 11, 12 will close preventing back-siphonage into the potable water supply.

The preferred embodiment of the invention includes two check O-rings 26 for forming a seal between the check valve assemblies 11, 12 and the interior of the valve body 13. In addition, face O-rings 27 form a seal between the valve body 13 and the end segments 16, 17, and sleeve O-rings 39 form a seal between the check valve assemblies 11, 12 and the interior of the valve body 13.

The preferred backflow prevention apparatus has three test cocks 28, 29 and 30 connected to the valve body 13 for use in testing pressure and fluid flow. As shown in FIG. 1, the test cock 28 is positioned on the valve body to allow the operator to test the fluid pressure of the inlet flow stream against the first check valve assembly 11. Test cock 29 is positioned for testing the middle pressure between the first check valve assembly 11 and the second check valve assembly 12, and the third test cock 30 allows the outlet pressure against the second check valve assembly 12 to be determined. The test cocks 28, 29, 30 are preferably positioned in linear alignment on the valve body 13 approximately 180 degrees from the pivot rod 18.

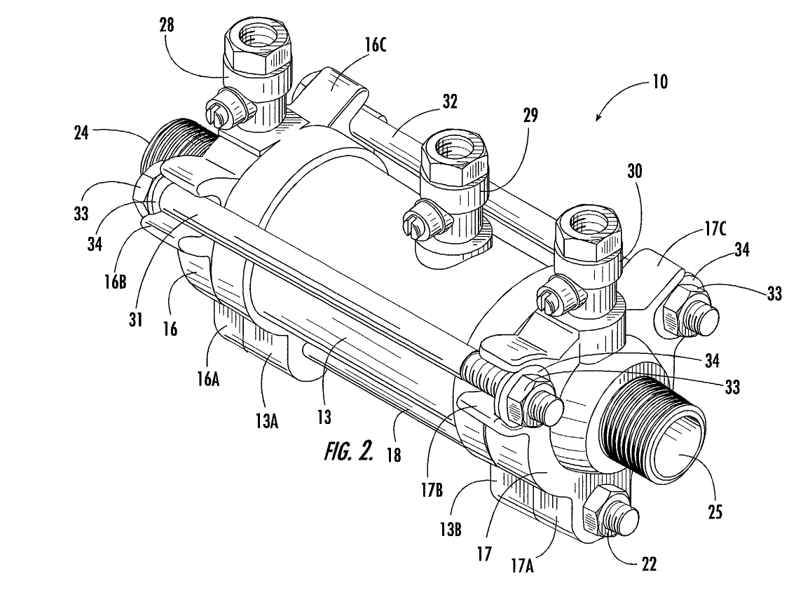

As is shown in FIG. 2, the backflow preventer apparatus 10 includes two connecting rods 31 and 32 extending from one valve body end segment 16 to the other valve body end segment 17. The connecting rods 31, 32 preferably are substantially similar in size and shape as the pivot rod 18, and run parallel to the pivot rod 18, the longitudinal axis of the valve body 13, and each other. The connecting rods 31, 32 and pivot rod 18 are preferably spaced approximately 120 degrees from each other.

The ends of the connecting rods 31, 32 are threaded and reside in bushings 16B, 17B and 16C, 17C, respectively. The bushings 16B, 17B, 16C, 17C are arcuate shaped and have an opening that allows the connecting rods to be placed in and removed from the bushings 16B, 17B, 16C, 17C. Bushings 16B and 16C protrude from end segment 16, while bushings 17B and 17C protrude from end segment 17. The connecting rods 31, 32 are held in place on the backflow preventer 10 by the frictional engagement of nuts 33 and washers 34 against bushings 16B, 17B, 16C, 17C. When so positioned, the connecting rods 31, 32 lock the valve body 13 into axial alignment with the end segments 16, 17, as shown in FIGS. 1 and 2.

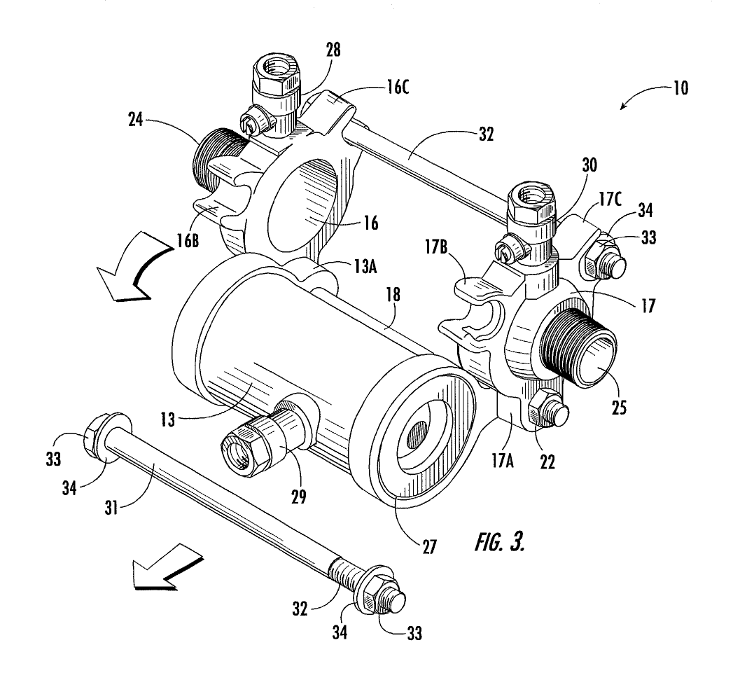

The connecting rods 31, 32 can be removed from the backflow preventer 10 when the nuts 33 and washers 34 are loosened or removed. As seen in FIG. 3, the removal of connecting rod 31 allows for valve body 13 to be pivotally moved in a single direction out of axial alignment with end segments 16 and 17, thus putting the backflow preventer 10 in the open position. Valve body 13 can be pivoted in the opposite direction when the connecting rod 32 is removed from its corresponding bushings 16C, 17C. When the backflow preventer 10 is in an open position, the check valve assemblies 11, 12 can be removed from the valve body 13, as shown in FIG. 4, while the rest of the backflow preventer 10 remains otherwise intact, and the valve body 13 stays connected to the end segments 16, 17. As such, inspection and maintenance of the check valves can be accomplished with minimal tools, effort and training on the part of the user. In addition, the risk of losing disassembled parts is reduced.

Unlike other backflow preventers, retaining clips or spacers are not needed to hold the check valve assemblies 11, 12 in place in the backflow preventer 10. Rather, the check valve assemblies 11, 12 are retained by simply pivoting the valve body 13 back into axial alignment with the end segments 16, 17.

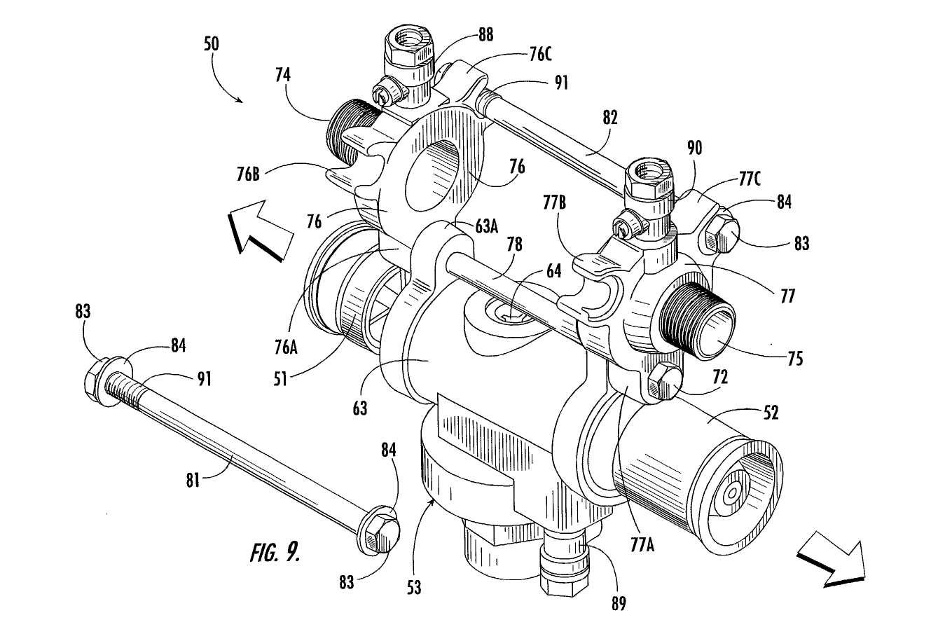

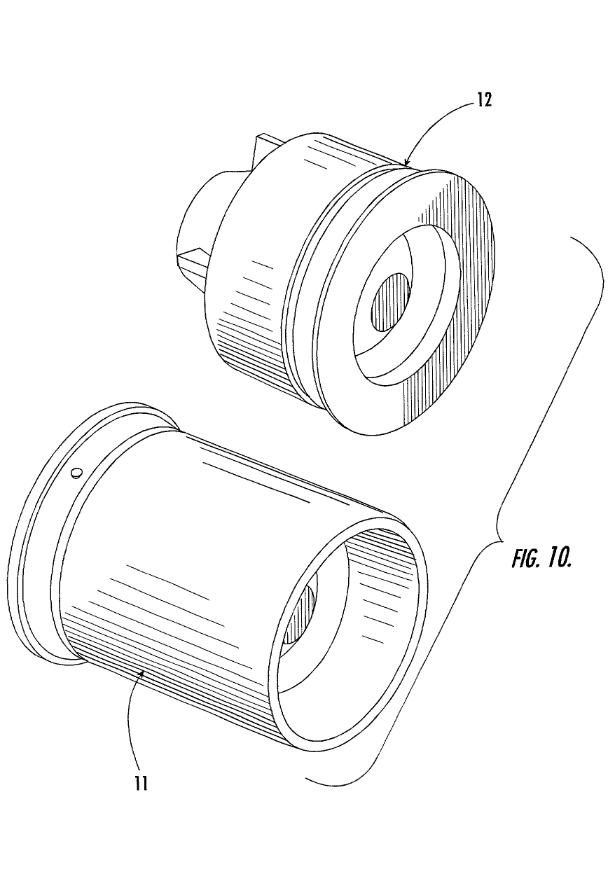

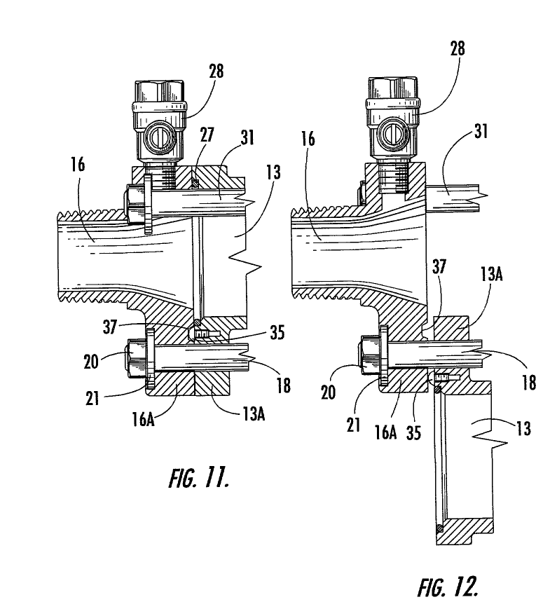

As can be seen in FIG. 1, alignment screws 35 and 36 are press fitted into opposite ends of the valve body 13, such that only the heads of the alignment screws 35, 36 protrude out from the valve body 13. End segments 16, 17 include opposing apertures 37, 38, respectively. When the backflow preventer 10 is in the closed position, the heads of alignment screws 35, 36 reside in apertures 37, 38, respectively, as shown in FIG. 1, forming a tighter seal between the end segments 16, 17 and valve body 13, and insuring proper alignment. FIGS. 11 and 13A provide an enlarged view of alignment screw 35 residing in aperture 37 shown in FIG. 1. When the valve body 13 is swung out of axial alignment with the end segments 16, 17, the alignment screws 35, 36 move out of apertures 37, 38, respectively, and the heads of the alignment screws 35, 36 ride against the face of the adjacent end segments 16, 17, thus causing the valve body 13 to separate from the end segments 16, 17. The face O-rings 27 float freely when the backflow preventer 10 is in the open position. FIG. 13B depicts the alignment screw 35 moving out of the aperture 37 as the valve body 13 swings out of axial alignment with an end segment 16. FIGS. 12 and 13C illustrate the alignment screw 35 when it has been moved outside of aperture 37 and is riding against the face of the end segment 16.

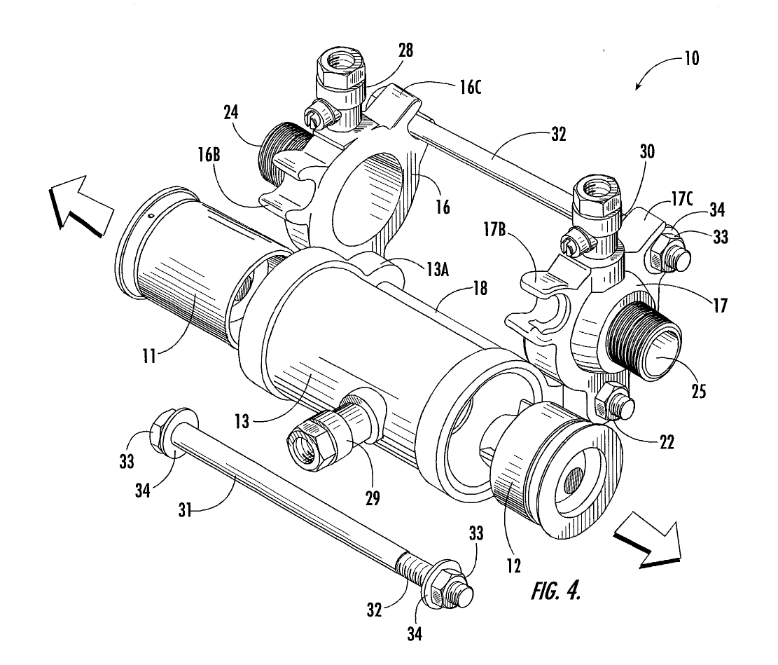

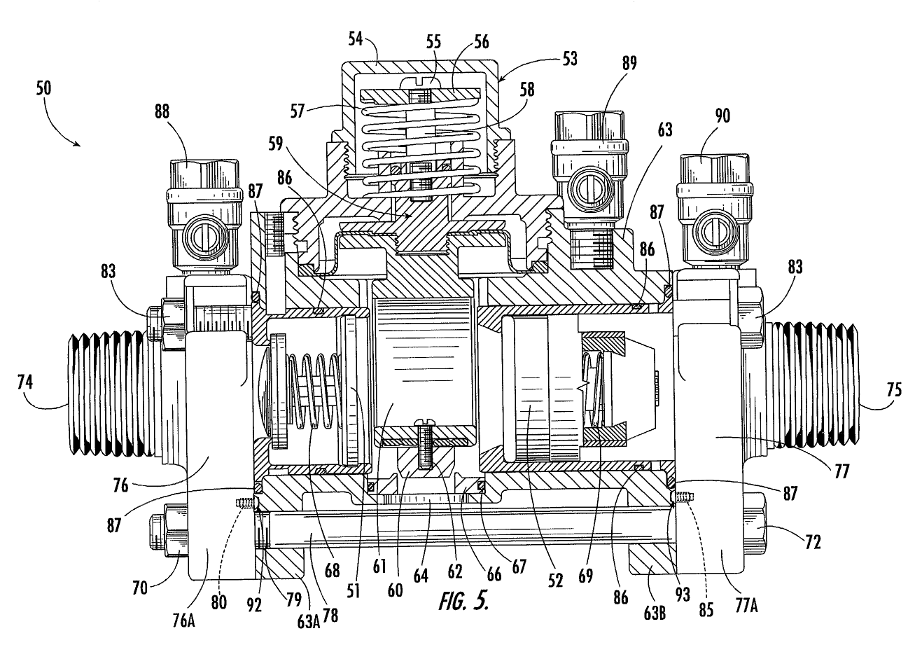

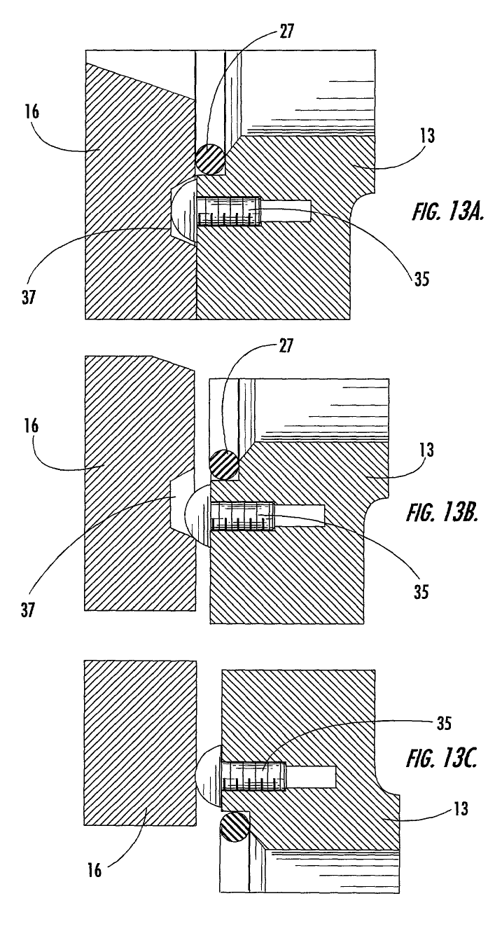

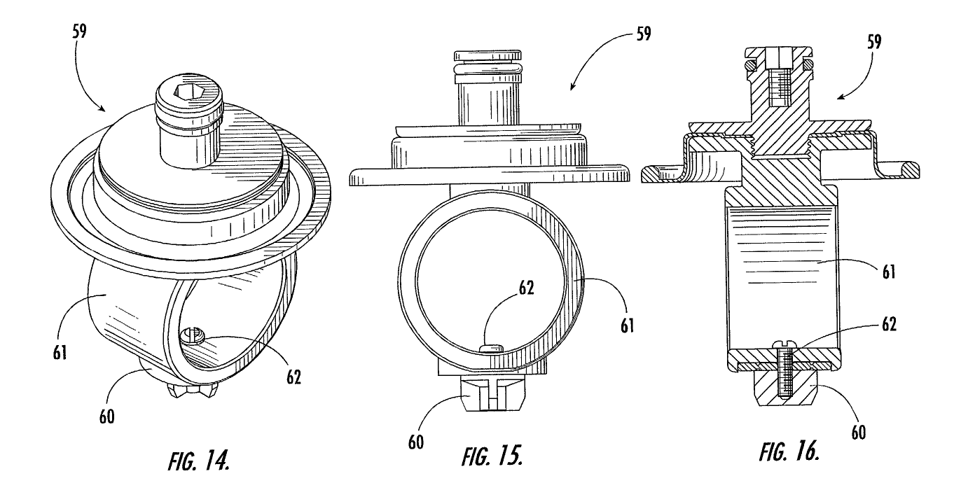

FIG. 5 shows a preferred alternative embodiment of a backflow preventer 50 of the present invention, which includes a relief valve 53. The relief valve 53 is positioned approximately mid-way between two check valve assemblies 51, 52. The relief valve 53 comprises a cap 54, a screw 55, a washer 56, a spring 57, a spacer 58, and a plunger assembly 59. The plunger assembly 59, shown in FIGS. 14, 15 and 16, includes a plug 60 connected to a valve stem 61 by means of a base screw 62. A relief port 64 is defined by a valve body 63, and a relief valve seat 66 is attached to the interior of the valve body 63 proximate to the relief port 64. The relief port 64 is located on the valve body 63 approximately 180 degrees from the cap 54. The plug 60 has a “T” shape that is received by the relief valve seat 65 when the relief valve 53 is in the closed position (as shown in FIG. 6), thereby preventing fluid flow through relief port 64. An O-ring 67 helps form a seal between the plug 60 and relief valve seat 66. Relief valve 53 is depicted in open position in FIG. 5.

The valve stem 61 of the relief valve 53 is of a size and shape that is nearly identical to that of the interior of the valve body 63. Preferably, the valve body 63 and valve stem 61 are cylindrical and the valve stem 61 has a circumference that is nearly that of the valve body 63 such that the valve stem 61 fits flush against the interior of the valve body 63. The valve stem 61 is hollow and open where it faces inlet aperture 74 and outlet aperture 75, thereby allowing for the free flow of fluid through the valve stem 61. This novel feature of the invention reduces head loss by eliminating the solid valve stem that obstructs fluid flow.

The backflow preventer 50 is structurally and functionally similar to the previous backflow preventer 10. Two check valve assemblies 51, 52 reside in the valve body 63. Springs 68, 69 bias check valve assemblies 51, 52, respectively, in a closed position. The check valve assemblies 51, 52 preferably have single piece check valves rather than multi-piece check valves that require field assembly. In addition, the check valve assemblies 51, 52 and the valve body 63 are designed so that the check valve assemblies 51, 52 can only be inserted into the valve body 63 in the correct direction. The valve body 63 is hollow and cylindrical, and preferably comprised of brass.

The backflow preventer 50 includes two end segments 76 and 77 pivotally attached to the valve body 63 by a pivot rod 78 that is connected to the exterior of the valve body 63 and runs parallel to the longitudinal axis of the valve body 63. The pivot rod 78 has screw threads 79 at opposite ends. The pivot rod 78 extends through the first end segment 76 through a hole defined by a bushing 76A that extends radially outwardly from an end segment 76, through bushings 63A and 63B extending radially outwardly from the valve body 63, and a bushing 77A extending radially outwardly the other end segment 77. The pivot rod 78 is held in place at the first end segment 76 by a nut 70 and a washer (not shown). The pivot rod 78 is likewise held in place at the second end segment 53 by a nut 72 and a washer. The pivot rod 78 enables the valve body 63 to pivotally move in and out of axial alignment with the end segments 76, 77 along a single axis parallel to a longitudinal axis of the valve body 63.

The longitudinal axis of valve body 63 defines a flow path therethrough. Fluid enters the backflow preventer 50 through an inlet aperture 74 defined by the valve body end segment 76, and exerts pressure on the first check valve assembly 51. Under static conditions, the check valves within the check valve assemblies 51, 52 are biased closed by springs 68, 69, respectively, and the relief valve 53 is biased in an open position by a spring 71. When the inlet pressure on the first check valve assembly 51 reaches a predetermined value, the first check valve assembly 51 opens allowing fluid to flow therethrough. When there is at least a predetermined differential in pressure between the inlet pressure against the first check valve assembly and the middle pressure in the area between the first check valve assembly 51 and the second check valve assembly 52, the relief valve 53 closes (plug 60 resides in valve seat 66 closing relief port 64). The second check valve assembly opens if there is a predetermined differential between the middle pressure and the outlet pressure, allowing fluid to flow therethrough. After passing through the second check valve assembly 52, the flow stream exits the backflow preventer 50 downstream through an outlet aperture 75 defined by valve body end segment 77.

In the event of a backpressure situation, both check valve assemblies 51, 52 will close preventing back-siphonage into the potable water supply. If, during such a backpressure situation, the second check valve assembly 52 fails to close, the relief valve 53 opens when the difference between the inlet pressure and middle pressure reaches a predetermined value. When the relief valve 53 opens (plug 60 is moved out of relief valve seat 66) fluid in the backflow preventer 50 is evacuated through the relief port 64. Thus, the relief valve 53 is a precautionary measure that is useful in a high hazard situation.

The preferred embodiment of the invention includes two check O-rings 86 for forming a seal between the check valve assemblies 51, 52 and the interior of the valve body 63. In addition, face O-rings 87 help form a seal between the valve body 63 and the end segments 76, 77.

The preferred backflow prevention apparatus has three test cocks 88, 89 and 90 connected to the valve body 63 for use in testing pressure and fluid flow. As shown in FIG. 5, test cock 88 is positioned on the valve body so as to allow the operator to test the fluid pressure of the inlet flow stream against the first check valve assembly 51. Test cock 89 is positioned for testing the middle pressure between the first check valve assembly 51 and the second check valve assembly 52, and test cock 90 permits the outlet pressure against the second check valve assembly 52 to be determined.

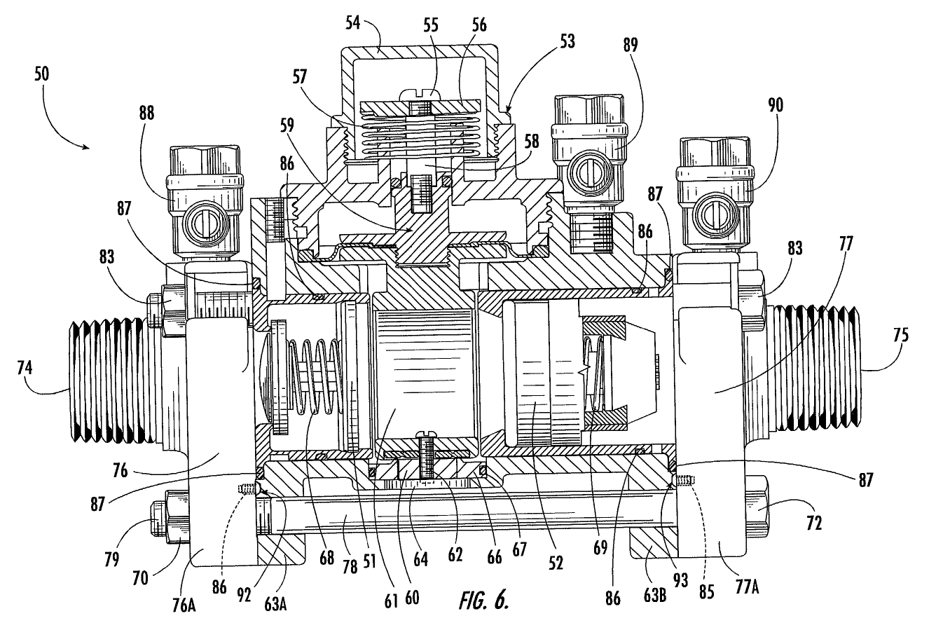

As is shown in FIGS. 7 and 8, respectively, the backflow preventer apparatus 50 includes two connecting rods 81 and 82 extending from one valve body end segment 76 to the other valve body end segment 77. The connecting rods 81, 82 preferably are substantially similar in size and shape as the pivot rod 78, and run parallel to the pivot rod 78, the longitudinal axis of the valve body 63, and each other. The connecting rods 81, 82 and pivot rod 78 are preferably spaced approximately 120 degrees from each other.

The ends of the connecting rods 81, 82 have threading 91 and reside in bushings 76B, 77B and 76C, 77C, respectively. The bushings 76B, 77B, 76C, 77C are arcuate shaped and have an opening that allows the connecting rods to be placed therein and removed therefrom. Bushings 76B and 76C protrude from end segment 76, while bushings 77B and 77C protrude from end segment 77. The connecting rods 81, 82 are held in place on the backflow preventer 50 by the frictional engagement of nuts 83 and washers 84 against bushings 76B, 77B, 76C, 77C. When so positioned, the connecting rods 81, 82 prevent the valve body 63 from moving out of axial alignment with the end segments 76, 77, thereby stabilizing the backflow preventer 50 in a closed position (depicted in FIG. 7).

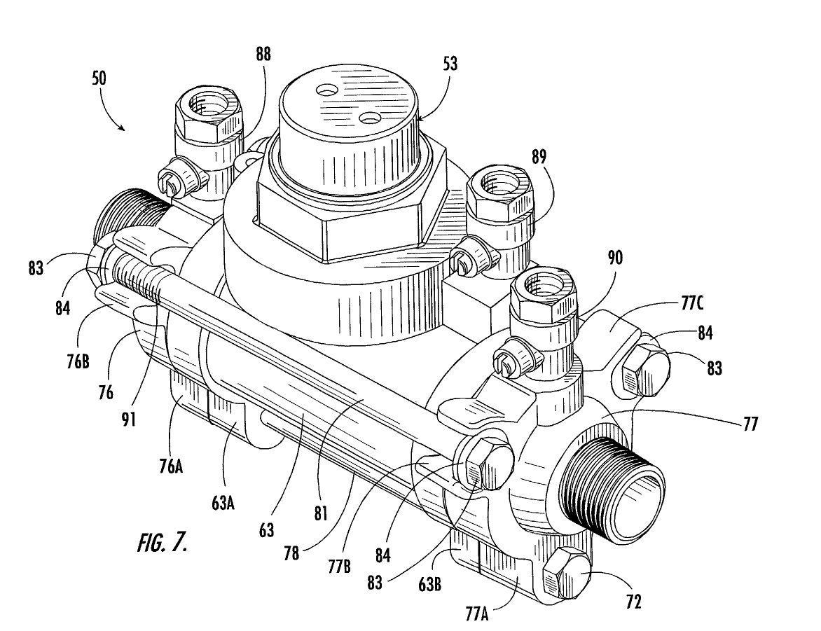

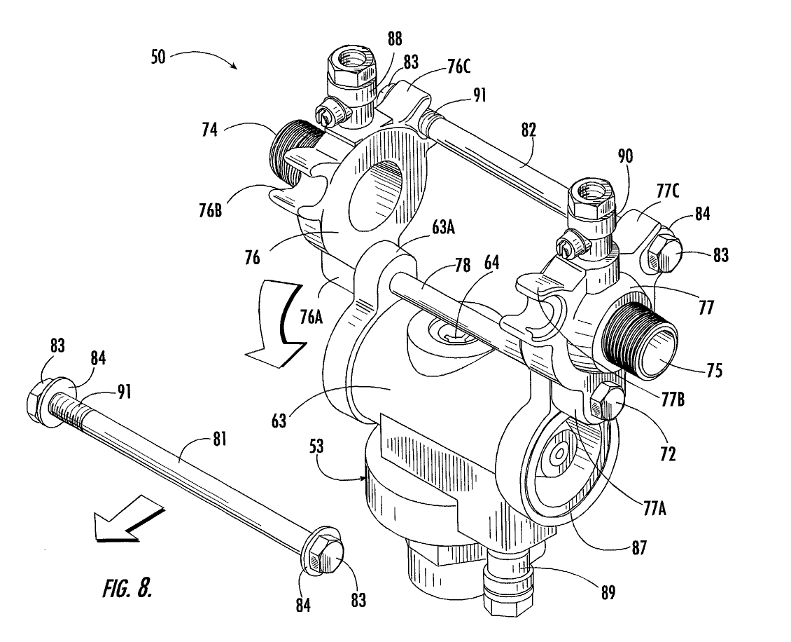

The connecting rods 81, 82 can be removed from the backflow preventer 50 when the frictional engagement between the nuts 83 and washers 84 is released. FIG. 8 shows a connecting rod 81 that has been removed from its bushings 76B and 77B, after the nuts 83 have been loosened from the washers 84. The removal of a connecting rod 81 allows for the valve body 63 to be pivotally moved out of axial alignment with the end segments 76 and 77, thus putting the backflow preventer 50 in the open position (shown in FIG. 8). Once the backflow preventer 50 is so positioned, the check valve assemblies 51, 52 can be removed from the valve body 63, as shown in FIG. 9.

As seen in FIG. 5, alignment screws 80 and 85 are press-fitted into the end segments 76, 77, respectively. The alignment screws 80, 85 are positioned such that only the heads of the alignment screws protrude out from the end segments 76, 77. The valve body 63 defines two apertures 92 and 93. When the backflow preventer 50 is in the closed position, the heads of alignment screws 80, 85 reside in apertures 92, 93 respectively, as shown in FIGS. 5 and 6. This forms a tighter seal between the end segments 76, 77 and valve body 63, and insures proper alignment. When the valve body 63 is swung out of axial alignment with the end segments 76, 77, alignment screws 80, 85 are forced out of apertures 92, 93 and the heads of the alignment screws 80, 85 ride against the face of the adjacent valve body 63, thus causing the end segments 76, 77 to separate from the valve body 63. This lets the face O-rings 87 float freely when the backflow preventer 50 is in the open position.

A swing-out backflow preventer is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A backflow prevention apparatus comprising:
a) a valve body having a longitudinal axis defining a flow stream therethrough;
b) an attachment member connected to exterior walls of said valve body;
c) a valve body end segment connected to said attachment member and having a flow opening therein, said valve body moveable between a closed position wherein said valve body is in axial alignment with said valve body and an open position wherein said valve body is out of axial alignment with said valve body end segment; and
d) a check valve assembly positioned within said valve body and maintained in operative position by said valve body in axial alignment with said valve body end segment, said check valve assembly removable from said valve body when said valve body end is moved out of axial alignment with said valve body end segment.

2. A backflow prevention apparatus comprising:
a) a valve body having a longitudinal axis defining a flow stream therethrough;
b) a pivot member connected to exterior walls of said valve body, said valve body being carried by said pivot member;
c) a valve body end segment connected to said pivot member and having a flow opening therein, said valve body pivotally moveable along an axis parallel to said longitudinal axis of said valve body between a closed position wherein said valve body is in axial flow alignment with said valve body end segment and an open position wherein said valve body is out of axial flow alignment with said valve body end segment; and
d) a check valve assembly positioned within said valve body and maintained in operative position by said valve body in axial flow alignment with said valve body end segment, said check valve assembly removable from said valve body when said valve body is moved out of axial flow alignment with said valve body end segment.

3. The backflow prevention apparatus of claim 2, wherein said valve body is carried by said pivot member for pivotal movement in clockwise and counterclockwise directions.

4. The backflow prevention apparatus of claim 2, wherein said check valve assembly comprises a single piece check valve.

5. The backflow prevention apparatus of claim 2, wherein said check valve assembly is shaped for being positioned within said valve body in one direction only.

6. A backflow prevention apparatus comprising:
a) a valve body having a longitudinal axis defining a flow stream therethrough;
b) a pivot member connected to exterior walls of said valve body, said valve body being carried by said pivot member;
c) first and second valve body end segments connected to said pivot member and having flow openings therein, said first valve body end segment longitudinally spaced apart from said second valve body end segment, said valve body pivotally moveable along an axis parallel to said longitudinal axis of said valve body between a closed position wherein said valve body is in axial flow alignment with said first and second valve body end segments and an open position wherein said valve body is out of axial flow alignment with said first and second valve body end segments; and
d) first and second check valve assemblies positioned within said valve body, said first check valve assembly longitudinally spaced apart from said second check valve assembly and maintained in operative position by said valve body in axial flow alignment with said first and second valve body end segments, said first and second check valve assemblies removable from said valve body when said valve body is moved out of axial flow alignment with said first and second valve body end segments.

7. The backflow prevention apparatus of claim 6, wherein said pivot member comprises a rod connected to said first and second valve body end segments and extending parallel to said longitudinal axis of said valve body.

8. A backflow prevention apparatus comprising:
a) a valve body having a longitudinal axis defining a flow stream therethrough;
b) an attachment member connected to exterior walls of said valve body;
c) a valve body end segment connected to said attachment member and having a flow opening therein, said valve body moveable between a closed position wherein said valve body is in axial alignment with said valve body and an open position wherein said valve body is out of axial alignment with said valve body end segment;
d) a check valve assembly positioned within said valve body and maintained in operative position by said valve body in axial alignment with said valve body end segment, said check valve assembly removable from said valve body when said valve body end is moved out of axial alignment with said valve body end segment; and
e) a pressure relief valve connected to said valve body.

9. A backflow prevention apparatus comprising:
a) a valve body having a longitudinal axis defining a flow stream therethrough;
b) a pivot member connected to exterior walls of said valve body, said valve body being carried by said pivot member;
c) first and second valve body end segments connected to said pivot member and having flow openings therein, said first valve body end segment longitudinally spaced apart from said second valve body end segment, said valve body pivotally moveable along an axis parallel to said longitudinal axis of said valve body between a closed position wherein said valve body is in axial flow alignment with said first and second valve body end segments and an open position wherein said valve body is out of axial flow alignment with said first and second valve body end segments;
d) first and second check valve assemblies positioned within said valve body, said first check valve assembly longitudinally spaced apart from said second check valve assembly and maintained in operative position by said valve body in axial flow alignment with said first and second valve body end segments, said first and second check valve assemblies removable from said valve body when said valve body is moved out of axial flow alignment with said first and second valve body end segments; and
e) a pressure relief valve connected to said valve body at a point between said first and second check valve assemblies.

10. The backflow prevention apparatus of claim 9, wherein said first and second check valve assemblies are positionable within said valve body in said flow stream, said first check valve assembly defining an inlet pressure of said flow stream, said second check valve assembly defining an outlet pressure of said flow stream, said first and second check valve assemblies defining a middle pressure of said flow stream therebetween.

11. The backflow prevention apparatus of claim 10, wherein said first and second check valve assemblies open and said relief valve closes when a difference between said inlet pressure and said middle pressure reaches a predetermined level.

12. The backflow prevention apparatus of claim 10, wherein said second check valve closes when a difference between said middle pressure and said outlet pressure reaches a predetermined level.

13. The backflow prevention apparatus of claim 10, wherein said pressure relief valve opens if a difference between said inlet pressure and said middle pressure falls below a predetermined level.
